(19) United States
(12) Patent Application Publication
(10) Pub. No.: US 2024/0347022 A1
(43) Pub. Date: Oct. 17, 2024

(54) Dynamic Power-Saving Mechanisms for Displaying an Image

(71) Applicant: Google LLC, Mountain View, CA (US)

(72) Inventors: Hsin Hsueh Li, New Taipei City (TW); Chien-Hui Wen, Cupertino, CA (US)

(73) Assignee: Google LLC, Mountain View, CA (US)

(21) Appl. No.: 18/753,558

(22) Filed: Jun. 25, 2024

Related U.S. Application Data
(60) Provisional application No. 63/659,604, filed on Jun. 13, 2024.

(51) Int. Cl. G09G 5/10; G09G 5/00

(52) U.S. Cl. CPC G09G 5/10; G09G 5/003; G09G 2320/0626; G09G 2320/0686; G09G 2330/023; G09G 2340/10

(57) ABSTRACT

Systems and techniques directed at dynamic power-saving mechanisms for displaying an image are disclosed. An electronic device determines an image to be displayed and an associated OPR for displaying the image. Based on the determined OPR, the electronic device generates a bionic image. Various mechanisms may be used to generate the bionic image. A display brightness value (DBV) or different blocking areas of the combined image may be used to generate the bionic image. The electronic device combines the image and the bionic image to form a combined image and presents the combined image on an emissive display. The combined image reduces a power expenditure of the emissive display that may otherwise be expended. The combined image may retain a high luminance for a focus area of the combined image while reducing the luminance for the remaining area (e.g., area outside of the focus area) of the combined image.

### CROSS-REFERENCE TO RELATED APPLICATION(S)

This application claims the benefit of U.S. Provisional Patent Application Ser. No. 63/659,604, filed on Jun. 13, 2024, the disclosure of which is incorporated by reference herein in its entirety.

### SUMMARY

This document describes systems and techniques directed at dynamic power-saving mechanisms for displaying an image. A bionic image is combined with an image to form a combined image, the combined image being configured to keep the luminance high for an area of focus for the combined image while reducing the luminance for the remaining area of the combined image. The reduction in luminance for a portion of the combined image may reduce the power consumption of an emissive device to display the combined image in comparison to displaying the original image.

In one implementation, a method includes determining an image to be displayed on an emissive display, the emissive display including a plurality of pixels. The method includes determining an on-pixel ratio (OPR) for the image, the OPR indicating a percentage of emitting pixels to non-emitting pixels for displaying the image. The method includes generating a bionic image based on the determined OPR and combining the bionic image with the image to form a combined image. The combined image is configured to have a higher luminance for a focus area of the combined image and reduce a luminance for an area outside of the focus area of the combined image effective to reduce a power expenditure by the emissive display. The method includes displaying the combined image on the emissive display. These and other implementations are described in further detail herein.

The details of one or more implementations are set forth in the accompanying Drawings and the following Detailed Description. Other features and advantages will be apparent from the Detailed Description, the Drawings, and the Claims. This Summary is provided to introduce subject matter that is further described in the Detailed Description. Accordingly, a reader should not consider the Summary to describe essential features or limit the scope of the claimed subject matter.

### BRIEF DESCRIPTION OF DRAWINGS

Apparatuses of and techniques for dynamic power-saving mechanisms for displaying an image are described with reference to the following drawings. The same numbers are used throughout the drawings to reference like features and components.

FIG. 1-1 illustrates an image and a bionic image that may be combined to function as a dynamic power-saving mechanism for displaying an image on a display.

FIG. 1-2 illustrates a combined image formed from the image and the bionic image of FIG. 1-1.

FIG. 2 illustrates an implementation of a dynamic power-saving mechanism for displaying an image.

FIG. 3 illustrates an implementation of a dynamic power-saving mechanism for displaying an image.

FIG. 4 illustrates an implementation of a dynamic power-saving mechanism for displaying an image.

FIG. 5 illustrates an example electronic device that may implement a dynamic power-saving mechanism for displaying an image.

FIG. 6 is a flow chart of a method for dynamically saving power to display an image.

### DETAILED DESCRIPTION

### Overview

Electronic devices, such as mobile devices, are indispensable in daily life. As such, it is important to reduce the power consumption, if possible, of various applications of an electronic device to ensure that the electronic device can remain powered during an entire day. The power used by a display, such as an emissive display, of the electronic device is proportional (e.g., linearly proportional) to the properties (e.g., color, shade) of the content to be displayed. For example, an image having a high luminance (e.g., bright colors, white theme) causes the emissive display to consume more power than an image having a lower luminance. A first image having an on-pixel ratio (OPR) higher than an OPR of a second image may require a display to consume more power to display the first image than to display the second image. Reducing the power necessary to display an image on a display of an electronic device may extend the battery life of the electronic device.

To this end, this document describes systems and techniques directed at dynamic power-saving mechanisms for displaying an image. In aspects, an electronic device determines an image to be displayed and an associated OPR for displaying the image. Based on the determined OPR, the electronic device generates a bionic image. A number of different mechanisms may be used to generate the bionic image. For example, a display brightness value (DBV) or different blocking areas of the combined image may be used to generate the bionic image. The electronic device combines the image and the bionic image to form a combined image and causes the presentation of the combined image on an emissive display. The combined image reduces a power expenditure of the emissive display that may otherwise be expended in displaying the image (e.g., an original image). For example, the combined image may retain a high luminance for a focus area of the combined image while reducing the luminance for the remaining area (e.g., area outside of the focus area) of the combined image.

The following discussion describes operating environments and techniques that may be employed in the operating environments and example methods. Although systems and techniques for dynamic power-saving mechanisms for displaying an image are described, it is to be understood that the subject of the appended Claims is not necessarily limited to the specific features or methods described. Rather, the specific features and methods are disclosed as example implementations and reference is made to the operating environment by way of example only.

### Example Apparatuses and Systems

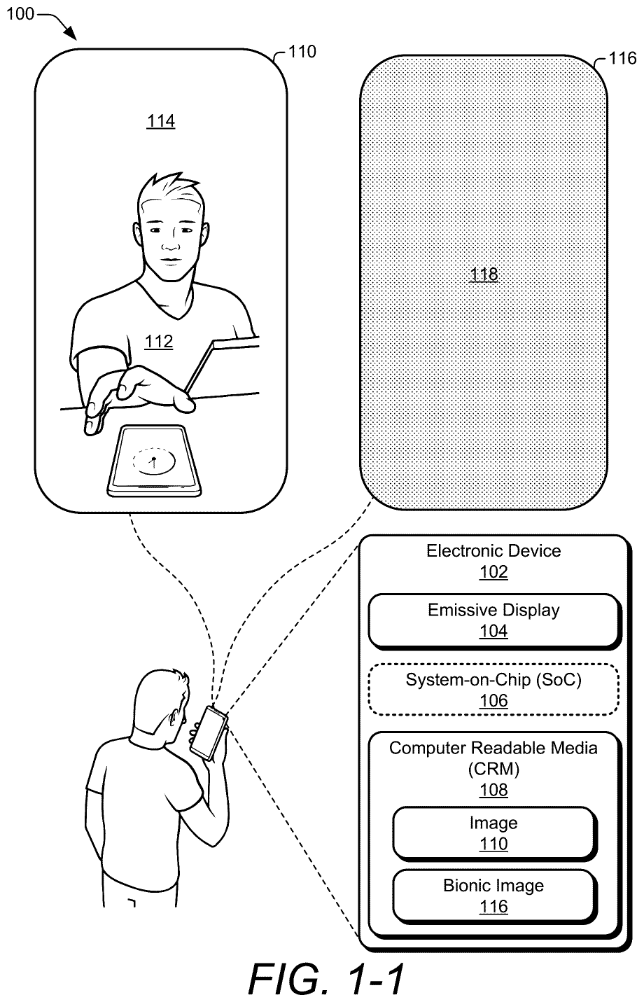

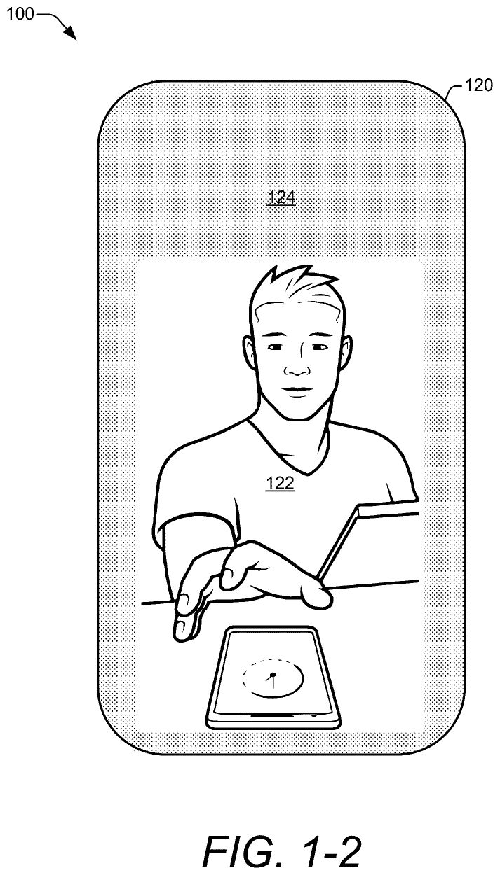

FIG. 1-1 illustrates a system 100 that includes an electronic device 102 configured to display an image 110 on an emissive display 104. The electronic device 102 may include computer readable media (CRM) 108. The CRM 108 may include an image 110 and a bionic image 116. In implementations, the image 110 to be displayed includes digital data representative of an image's visual content. FIG. 1-1 illustrates the visual content of the digital data representative of the image 110 for illustrative purposes only.

As illustrated, the image 110 includes a focus area 112 and a remaining area 114 (e.g., an area outside of the focus area 112). The focus area 112 may include a first subset of pixel data that may be of interest to a user and may be determined based on coordinates within the image 110, a size of an object, an object identity, a luminance distribution, or the like. The focus area 112 may have a at least a first luminance or a first set of luminosities, while the remaining area 114 may have at least a second luminance or a second set of luminosities. The remaining area 114 may include a second subset of pixel data that may not be of interest (or of less interest) to the user. Displaying the image 110 with the focus area 112 at the first luminance or first set of luminosities and the remaining area 114 at the second luminance or second set of luminosities may cause the electronic device 102 to expend a first amount of power.

However, to reduce the first amount of power otherwise caused by displaying the image 110, the electronic device 102 may generate a bionic image 116 with a lower luminance 118 than an average luminance of the remaining area 114 (e.g., the area outside of the focus area 112) of the image 110. The electronic device 102 may generate the bionic image 116 based on various mechanisms as discussed herein. For example, a system-on-chip (SoC) 106, coupled to the emissive display 104, associated the electronic device 102 may generate the bionic image 116.

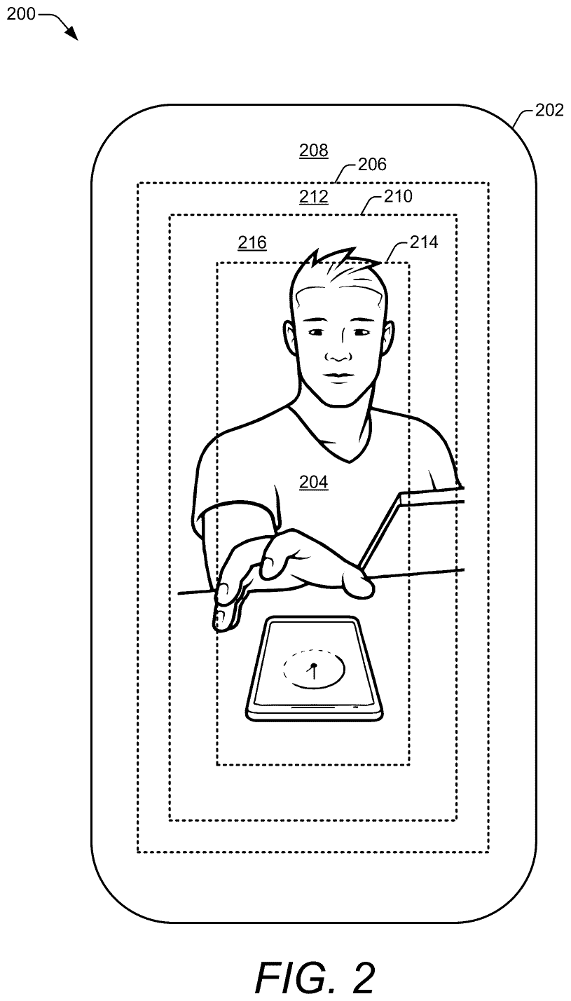

The bionic image 116 may be combined with the image 110 to form a combined image 120 and presented on the emissive display 104, as shown in FIG. 1-2. As illustrated, the combined image 120 includes a focus area 122 having a high luminance and an area 124 outside of the focus area 122 having a lower luminance. In comparison to the first amount of power expended by the electronic device 102 in presenting the image 110, the presentation of the combined image 120 on emissive display 104 causes the electronic devices 102 to expend a second amount of power, which is less than the first amount of power. In this way, the presentation of the combined image 120 reduces the power expenditure by the emissive display 104 of the electronic device 102.

In an implementation, the electronic device 102 determines the image 110 to be displayed on the emissive display 104 of the electronic device 102. Upon this determination, the electronic device 102 determines an OPR for the image 110. The OPR indicates a percentage of emitting pixels to non-emitting pixels necessary to display the image 110. The electronic device 102 then generates a bionic image 116 based on the OPR and combines the bionic image 116 with the image 110 to form a combined image 120. The electronic device 102 then displays the combined image 120 on the emissive display 104, reducing the power expenditure of the emissive display 104 in comparison to displaying the image 110 alone.

In an additional implementation, the electronic device 102 displays, as a first frame, the image 110 on the emissive display 104. Upon displaying the image 110, the electronic device 102 determines an OPR for the image 110 and generates the bionic image 116 based on the OPR. The electronic device 102 then combines the bionic image 116 with the image 110 to form the combined image 120. The electronic device 102 then displays the combined image 120, as a second frame, on the emissive display 104.

FIG. 2 illustrates an implementation of a dynamic power-saving mechanism 200 for displaying an image 202 with a focus area 204. The mechanism 200 includes defining a first blocking window 206 that is applied to the image 202. A first OPR is calculated for an area 208 of the image 202 outside of the first blocking window 206. A bionic image may then be generated and applied to the area 208 of the image 202 outside of the first blocking window 206.

The mechanism 200 includes defining a second blocking window 210 that is applied to the image 202. The second blocking window 210 is smaller than the first blocking window 206. A second OPR is calculated for an area 212 of the image 202 outside of the second blocking window 210. A bionic image 116 may then be generated and applied to the area 212 of the image 202 outside of the second blocking window 210. The bionic image 116 applied to the area 212 outside of the second blocking window 210 may provide a greater power reduction since the area 212 outside of the second blocking window 210 is larger than the area 208 outside of the first blocking window 206. However, the electronic device 102 may use the first blocking window 206 if the second OPR is substantially the same as the first OPR.

The mechanism 200 includes defining a third blocking window 214 that is applied to the image 202. The third blocking window 214 is smaller than the second blocking window 210. A third OPR is calculated for an area 216 of the image 202 outside of the third blocking window 214. A bionic image may then be generated and applied to the area 216 of the image 202 outside of the third blocking window 214. Likewise, the bionic image applied to the area 216 outside of the third blocking window 214 may provide a greater power reduction because the area 216 outside of the third blocking window 214 is larger than the area 212 outside of the second blocking window 210. However, the electronic device 102 may use the second blocking window 210 if the third OPR is substantially the same as the second OPR. Likewise, the electronic device 102 may use the first blocking window 206 if the third OPR is substantially the same as the first OPR.

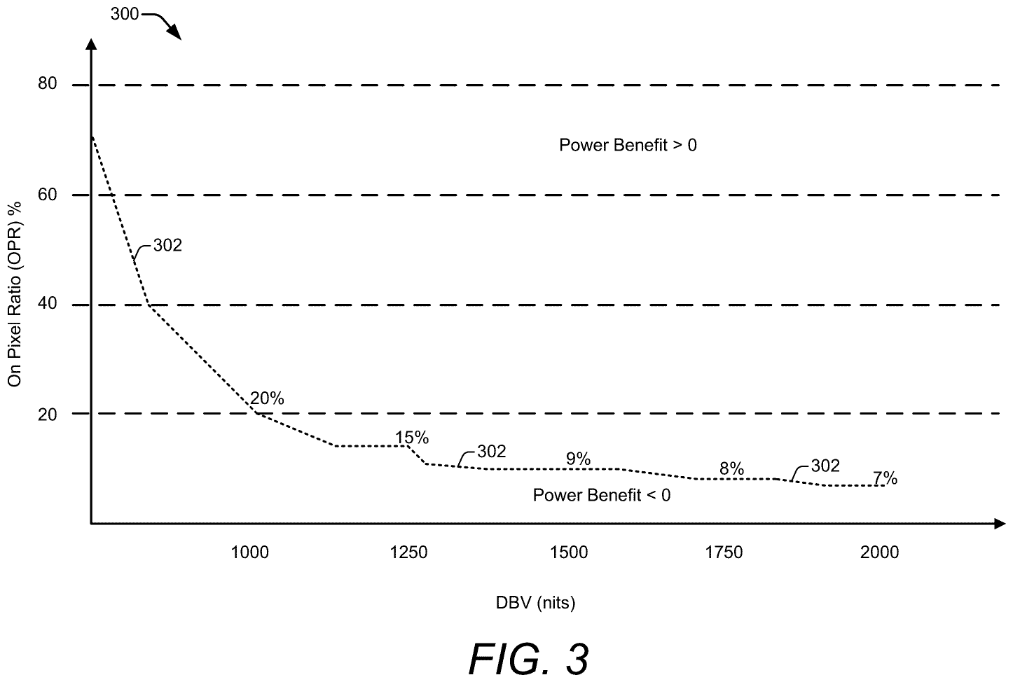

FIG. 3 illustrates a chart 300 of an OPR percentage to a DBV (e.g., luminance) for an example implementation of a dynamic power-saving mechanism for displaying an image (e.g., image 110). The dynamic power-saving mechanism includes the generation of a bionic image (e.g., bionic image 116) when the OPR is above a threshold 302. As illustrated, the threshold 302 changes depending on the DBV (e.g., luminance) of an emissive display (e.g., emissive display 104). If the OPR for a specified DBV exceeds the threshold 302, then an electronic device (e.g., electronic device 102) generates a bionic image (e.g., bionic image 116) to combine with the image to form a combined image (e.g., combined image 120) to display on the emissive display 104. In an implementation, if the OPR for a specified DBV fails to exceed the threshold 302, then the electronic device displays the image 110 alone on the emissive display 104. The threshold 302 indicates a reduction of power consumption from the generation and combination of the bionic image 116 with the image to form the combined image. In the instances where the OPR is below the threshold 302, there is not a reduction of power consumption due to the power required to generate the bionic image 116 and combine the bionic image 116 with the image.

In some aspects, the power-saving mechanism may include determining a first DBV of the emissive display 104 to display the image. A first threshold OPR corresponds to the first DBV. The dynamic power-saving mechanism combines the bionic image 116 with the image when the OPR exceeds the first threshold OPR. For example, for a DBV of 1000 nits, the threshold OPR is 20%. In other words, the electronic device does not generate the bionic image 116 to combine with the image if the OPR for the image, with a DBV of 1000 nits, is less than 20%. If the OPR is above 20%, then the electronic device generates a bionic image 116 and combines the bionic image 116 with the image to form a combined image.

In additional aspects, the power-saving mechanism includes determining a second DBV of the emissive display 104 to display the image. A second threshold OPR corresponds to the second DBV. The dynamic power-saving mechanism includes combining the bionic image 116 with the image when the OPR exceeds the second threshold OPR. For example, for a DBV of 1250 nits, the threshold OPR is 15%. In other words, the electronic device does not generate the bionic image 116 to combine with the image if the OPR for the image, with a DBV of 1250 nits, is less than 15%. If the OPR is above 15%, then the electronic device generates the bionic image 116 and combine the bionic image 116 with the image to form a combined image.

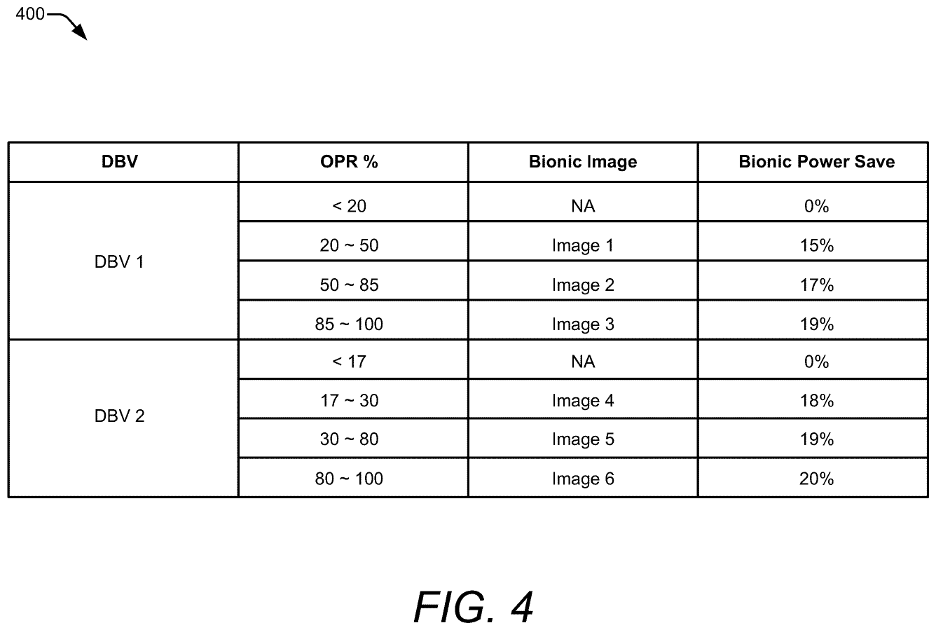

FIG. 4 illustrates a chart 400 for an example implementation of a dynamic power-saving mechanism for displaying an image 110. The mechanism includes determining a DBV of the emissive display (e.g., emissive display 104) to display an image (e.g., image 110). For a first DBV, the electronic device 102 may generate a first bionic image and combine the first bionic image with the image (e.g., image 110) when the OPR of the emissive display 104 is within a first range. For example, for an OPR percentage of 20˜50 for the first DBV, a first bionic image may be combined with the image (e.g., image 110). The electronic device (e.g., electronic device) 102 may generate and combine a second bionic image with the image (e.g., image 110) when the OPR is within a second range. For an OPR percentage of 50˜85 for the first DBV, a second bionic image may be combined with the image (e.g., image 110). The electronic device (e.g., electronic device 102) may generate and combine a third bionic image with the image (e.g., image 110) when the OPR is within a third range. For an OPR percentage of 85˜100 for the first DBV, a third bionic image may be combined with the image (e.g., image 110). For the first DBV, when the OPR percentage is less than the lower limit of the first range (e.g., 20%), the electronic device (e.g., electronic device 102) will not generate a bionic image 116 to be combined with the image (e.g., image 110).

For a second DBV, the electronic device (e.g., electronic device 102) may generate a fourth bionic image and combine the fourth bionic image with the image (e.g., image 110) when the OPR of the emissive display (e.g., emissive display 104) is within a fourth range. For example, for an OPR percentage of 17˜30 for the second DBV, a fourth bionic image may be combined with the image (e.g., image 110). The electronic device (e.g., electronic device 102) may generate and combine a fifth bionic image with the image (e.g., image 110) when the OPR is within a fifth range. For an OPR percentage of 30˜80 for the second DBV, a fifth bionic image may be combined with the image (e.g., image 110). The electronic device (e.g., electronic device 102) may generate and combine a sixth bionic image with the image (e.g., image 110) when the OPR is within a sixth range. For an OPR percentage of 80˜100 for the second DBV, a sixth bionic image may be combined with the image (e.g., image 110). For the second DBV, when the OPR percentage is less than the lower limit of the fourth range (e.g., 17%), the electronic device (e.g., electronic device 102) does not generate a bionic image (e.g., bionic image 116) to be combined with the image (e.g., image 110).

The DBV, OPR percentages, number of bionic images, and percentage of power saved are shown in FIG. 4 for illustrative purposes and may be varied as would be appreciated by one of ordinary skill in the art having the benefit of this disclosure. For example, a single DBV may include more or fewer than three ranges and more or fewer than three bionic images, and the ranges and percentage of power saved may differ from what is shown in FIG. 4.

### Example Electronic Device

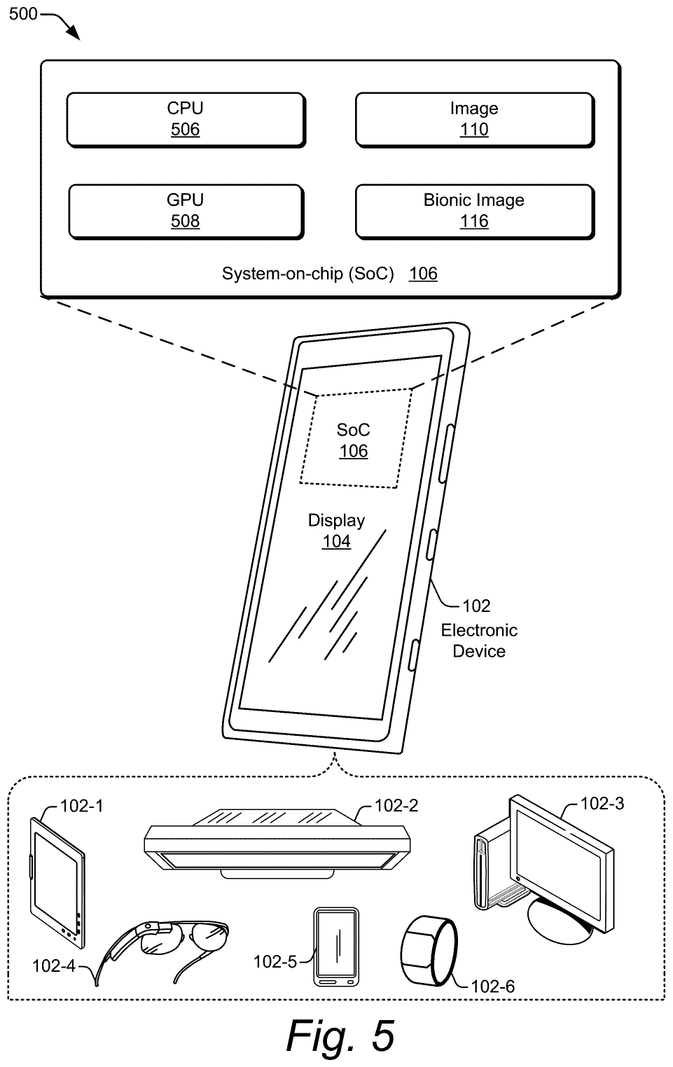

FIG. 5 illustrates a system 500 that includes an example electronic device 102 that includes a dynamic power-saving mechanism for displaying an image in accordance with one or more implementations. The electronic device 102 may include additional components and interfaces omitted from FIG. 5 for the sake of clarity. The electronic device 102 is illustrated with various non-limiting example electronic devices 102: a smart display 102-1, a smart television 102-2, a desktop computer 102-3, computing glasses 102-4, a tablet 102-5, and a computing watch 102-6. Other devices may also be used, such as a security display, a drawing pad, a netbook, an e-reader, forms of a home-automation and control system, a wall display, and a virtual-reality headset, to name just a few examples. Note that the electronic device 102 may be wearable, non-wearable but mobile, or relatively immobile (e.g., desktops and appliances), all without departing from the scope of the present teachings.

The electronic device 102 includes an SoC 106 and may further include one or more processors 506. The processor(s) 506 can include, as non-limiting examples, an SoC, an application processor (AP), a central processing unit (CPU), or a graphics processing unit (GPU) 508. The processor(s) 506 generally executes commands and processes utilized by the electronic device 102 and an operating system installed thereon. For example, the processor(s) 506 may perform operations to display graphics of the electronic device 102 on one or more displays 104 and can perform other specific computational tasks.

The electronic device 102 may also include computer-readable storage media (CRM). The CRM may be a suitable storage device configured to store device data of the electronic device 102, user data, and multimedia data. The CRM may store an operating system that generally manages hardware and software resources (e.g., the applications) of the electronic device 102 and provides common services for applications stored on the CRM. The operating system and the applications are generally executable by the processor(s) 506 to enable communications and user interaction with the electronic device 102. One or more processor(s) 506, such as a GPU 508, perform operations to display graphics and images of the electronic device 102 on the one or more displays 104 and can perform other specific computational tasks. The one or more displays 104 may be emissive displays. The processor(s) 506 can be single-core or multiple-core processors.

The electronic device 102 may also include input/output (I/O) ports. The I/O ports allow the electronic device 102 to interact with other devices or users. The I/O ports may include any combination of internal or external ports, such as universal serial bus (USB) ports, audio ports, Serial ATA (SATA) ports, PCI-express-based ports or card-slots, secure digital input/output (SDIO) slots, and/or other legacy ports.

The electronic device 102 may further include one or more images (e.g., image 110) and one or more bionic images (e.g., bionic image 116). A bionic image 116 may be combined with an image 110 to form a combined image configured to reduce a power expenditure by the emissive display 104 of the electronic device 102 as discussed herein.

### Example Methods

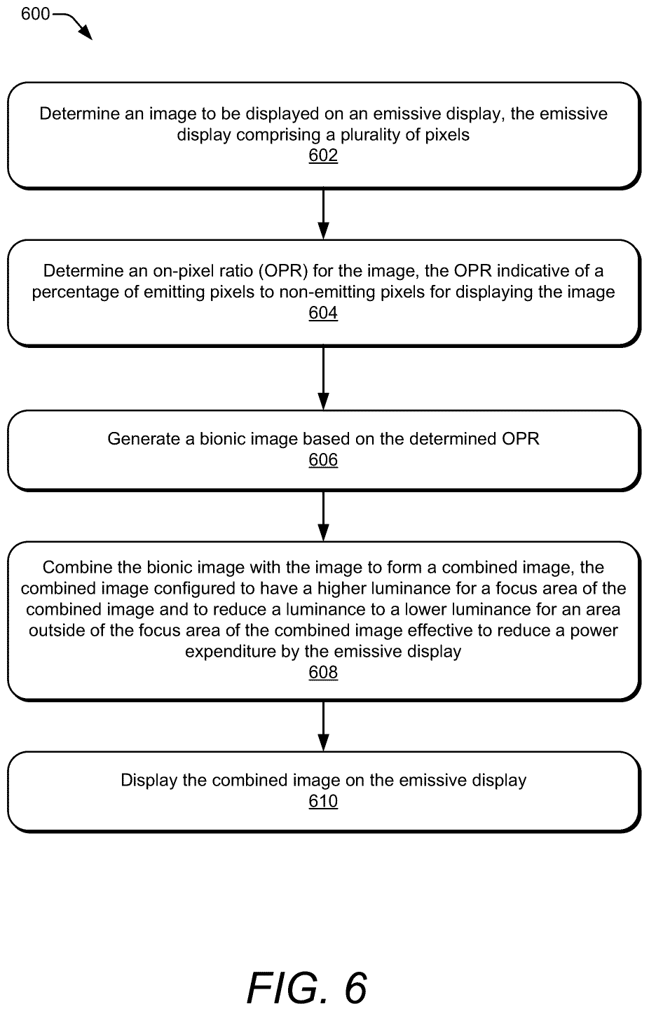

Example methods are described below with reference to the flow chart of FIG. 6. FIG. 6 is a flow chart 600 illustrating an example method for reducing a power expenditure of an emissive display. The flow chart 600 includes five blocks 602, 604, 606, 608, and 610. The operations of the example processes can be performed by electronic circuit components as described herein. For example, the operations may be performed by an SoC 106, 106.

At 602, an image to be displayed on an emissive display having a plurality of pixels is determined. For example, it may be determined to display an image (e.g., image 110) having a focus area 112 and a remaining area 114 (e.g., the area outside of the focus area 112). At 604, an OPR of the image is determined, the OPR indicative of a percentage of emitting pixels to non-emitting pixels for displaying the image. For example, the formula OPR=DBV^{2.2}τ(a*R^{2.2}+b*G^{2.2}.+C*B^{2.2}) may be used to calculate the OPR. To calculate the OPR, the DBV and an amount of red (R), green (G), and blue (B) of the emissive display to display the image may be determined. The amount of R, G, and B necessary to display the image (e.g., image 110) on the emissive display 104 may be used to determine the values of the weighting parameters a, b, and c.

At 606, a bionic image based on the determined OPR is generated. For example, a bionic image (e.g., bionic image 116) having a reduced luminance 118 in comparison to the image (e.g., image 110) may be generated based on the determined OPR. At 608, the bionic image is combined with the image to form a combined image, the combined image configured to have a higher luminance for a focus area of the combined image and to reduce a luminance to a lower luminance for an area outside of the focus area of the combined image, which effectively reduces a power expenditure by the emissive display. For example, the combined image (e.g., combined image 120) may include a focus area 122 that has a higher luminance than the luminance of the remaining area 124 (e.g., area outside of the focus area 122) of the combined image (e.g., combined image 120). The lower luminance of the remaining area 124 of the combined image (e.g., combined image 120) is configured to reduce the power expenditure of the emissive display 104. At 610, the combined image is displayed on the emissive display.

For the methods described herein and the associated flow chart(s) and flow diagram(s), the orders in which operations are shown and/or described are not intended to be construed as a limitation. Instead, any number or combination of the described method operations can be combined in any order to implement a given method or an alternative method, including by combining operations from the flow chart or diagram and the earlier-described schemes and techniques into one or more methods. Operations may also be omitted from or added to the described methods. Further, described operations can be implemented in fully or partially overlapping manners.

### Conclusion

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Terms such as “above,” “below,” or “underneath” are not intended to require any particular orientation of a device. Rather, a first layer or component being provided “above” a second layer or component is intended to describe the first layer being at a higher Z-dimension than the second layer or component within the particular coordinate system in use. It will be understood that should the component be provided in another orientation, or described in a different coordinate system, then such relative terms may be changed.

Although implementations for a dynamic power-saving mechanism for displaying an image have been described in language specific to certain features and/or methods, the subject of the appended claims is not necessarily limited to the specific features or methods described. Rather, the specific features and methods are disclosed as example implementations for a dynamic power-saving mechanism for displaying an image.

What is claimed is:

1. A method comprising:
determining an image to be displayed on an emissive display, the emissive display comprising a plurality of pixels;
determining an on-pixel ratio (OPR) for the image, the OPR indicative of a percentage of emitting pixels to non-emitting pixels for displaying the image;
generating a bionic image based on the determined OPR;
combining the bionic image with the image to form a combined image, the combined image configured to have a higher luminance for a focus area of the combined image and to reduce a luminance to a lower luminance for an area outside of the focus area of the combined image effective to reduce a power expenditure by the emissive display; and
displaying the combined image on the emissive display.

2. The method of claim 1, wherein the bionic image is generated by a system-on-chip (SoC), the SoC operatively coupled to the emissive display.

3. The method of claim 1, wherein determining the OPR of the image further comprises:
determining a display brightness value (DBV) of the emissive display;
determining an amount of red (R), green (G), and blue (B) of the emissive display displaying the image to calculate a weighting parameter, a, for R, a weighting parameter, b, for G, and a weighting parameter, c, for B; and
applying a formula to determine the OPR, the formula comprising:
$$OPR = {DBV}^{2.2} \sum ( a * {R}^{2.2} + b * {G}^{2.2} . + c * {B}^{2.2} ) .$$

4. The method of claim 3, wherein generating the bionic image further comprises:
defining a first blocking window of the image;
applying the first blocking window to the image; and
calculating a first OPR of an area of the image outside of the first blocking window.

5. The method of claim 4, wherein generating the bionic image further comprises:
defining a second blocking window of the image, the second blocking window being smaller than the first blocking window;
applying the second blocking window to the image; and
calculating a second OPR of an area of the image outside of the second blocking window.

6. The method of claim 5, wherein generating the bionic image further comprises:
defining a third blocking window of the image, the third blocking window being smaller than the second blocking window;
applying the third blocking window to the image; and
calculating a third OPR of an area of the image outside of the third blocking window.

7. The method of claim 6, wherein the bionic image is based on the first OPR, the second OPR, or the third OPR.

8. The method of claim 3, further comprising:
determining a first DBV of the emissive display while displaying the image, wherein a first threshold OPR corresponds to the first DBV; and
wherein combining the bionic image with the image further comprises combining the bionic image with the image when the determined OPR exceeds the first threshold OPR.

9. The method of claim 8, further comprising:
determining a second DBV of the emissive display while displaying a second image, wherein a second threshold OPR corresponds to the second DBV, wherein the second DBV differs from the first DBV and the second threshold OPR differs from the first threshold OPR; and
determining an OPR of the emissive display while displaying the second image; and
wherein combining the bionic image with the image further comprises combining the bionic image with the second image when the determined OPR of the emissive display while displaying the second image exceeds the second threshold OPR.

10. The method of claim 3, further comprising determining a DBV of the emissive display while displaying the image, the DBV comprising a first DBV and a second DBV.

11. The method of claim 10, wherein combining the bionic image with the image, for the first DBV, further comprises:
combining a first bionic image with the image to form the combined image when the OPR of the emissive display is within a first range;
combining a second bionic image with the image to form the combined image when the OPR of the emissive display is within a second range; and
combining a third bionic image with the image to form the combined image when the OPR of the emissive display is within a third range.

12. The method of claim 11, wherein combining the bionic image with the image, for the second DBV, further comprises:
combining a fourth bionic image with the image to form the combined image when the OPR of the emissive display is within a fourth range;
combining a fifth bionic image with the image to form the combined image when the OPR of the emissive display is within a fifth range; and
combining a sixth bionic image with the image to form the combined image when the OPR of the emissive display is within a sixth range.

13. The method of claim 3, further comprising:
defining a blocking area of the emissive display and calculating a first OPR of an area of the emissive display outside of the blocking area;
determining a DBV of the emissive display while displaying the image, wherein a threshold OPR corresponds to the DBV;
determining whether the first OPR exceeds the threshold OPR; and
determining a first range of OPR, a second range of OPR, and a third range of OPR for the DBV;
wherein combining the bionic image with the image to form the combined image further comprises:
combining a first bionic image with the image and displaying the combined image on the emissive display when the OPR falls within the first range of OPR;
combining a second bionic image with the image and displaying the combined image on the emissive display when the OPR falls within the second range of OPR; and
combining a third bionic image with the image and displaying the combined image on the emissive display when the OPR falls within the third range of OPR.
